(19) United States
(12) Patent Application Publication
(10) Pub. No.: US 2024/0083712 A1
(43) Pub. Date: Mar. 14, 2024

(54) ELEVATOR LANDING CONTROL SYSTEM

(71) Applicant: Industry-University Cooperation Foundation Sunmoon University, Asan-si (KR)

(72) Inventors: Jong Hwan YUN, Icheon-si (KR); Min Soo KANG, Asan-si (KR)

(73) Assignee: Industry-University Cooperation Foundation Sunmoon University, Asan-si (KR)

(21) Appl. No.: 18/176,029

(22) Filed: Feb. 28, 2023

(30) Foreign Application Priority Data
Sep. 8, 2022 (KR) 10-2022-0113848

(51) Int. Cl. B66B 1/42

(52) U.S. Cl. CPC B66B 1/42

(57) ABSTRACT

Disclosed herein is an elevator landing control system according to various embodiments of the present disclosure for achieving the above-described objects. The elevator landing control system includes an upper frame provided in an upward direction of a cage and provided with a main rope connected thereto, a position adjusting device connecting the cage and the upper frame, and a sensor device configured to detect a landing error between a floor of the cage and a floor of a platform, wherein the position adjusting device may adjust a distance between the upper frame and the cage based on the landing error detected from the sensor device to correct a height of the cage.

### CROSS-REFERENCE TO RELATED APPLICATION

This application claims the benefit of Korean Patent Application No. 10-2022-0113848, filed on Sep. 8, 2022, in the Korean Intellectual Property Office, the disclosure of which is incorporated herein by reference.

### BACKGROUND

### 1. Field

The present disclosure relates to an elevator landing control system, and more specifically, to a landing control system capable of correcting a step difference between a platform floor and an elevator floor through positional compensation.

### 2. Description of the Related Art

Today, with the development of building technology, high-rise buildings and even deep underground buildings have been built. Therefore, in most buildings, an elevator, which is a machine capable of vertically moving up and down, is provided to facilitate the movement of people or freight to higher floors or underground.

In general, a fixed pulley is installed at an uppermost position of an operating passage of the elevator. The fixed pulley is connected to a thick steel rope (e.g., a lift line), a cage in which people or objects may be boarded is connected to one end of the rope, and a counterweight is connected to the other end thereof. The counterweight is provided to have a weight similar to the cage or a weight equivalent to 1.5 times the weight of the cage and serves to reduce a load on a motor. For example, when the motor winds the rope in a forward direction, the cage may move up, and when the motor winds in a reverse direction, the cage may move down.

Meanwhile, in the elevator, a change in the elasticity of the rope may occur due to a change in amount of load caused by passengers getting on or off the cage, and thus, a landing error may occur between a platform floor and a cage floor. The landing error is related to a level difference between the platform floor and the cage floor when the elevator (or the cage) is stopped.

Such a landing error may cause a dangerous situation, such as getting a user's foot caught on a step generated by a step difference, when a passenger at a platform gets on the elevator or when a passenger in the cage gets off the elevator.

### SUMMARY

The present disclosure is directed to providing an elevator landing control system capable of correcting a step difference between a platform floor and an elevator floor through positional compensation of the elevator.

The objects of the present disclosure are not limited to the above-described objects, and other objects that are not mentioned will be able to be clearly understood by those skilled in the art from the following description.

An elevator landing control system according to one embodiment of the present disclosure for achieving the object is disclosed. The elevator landing control system includes an upper frame provided in an upward direction of a cage and provided with a main rope connected thereto, a position adjusting device configured to connect the cage and the upper frame, and a sensor device configured to detect a landing error between a floor of the cage and a floor of a platform, wherein the position adjusting device adjusts a distance between the upper frame and the cage based on the landing error detected from the sensor device to correct a height of the cage.

The elevator landing control system may further include a tilt measuring device configured to divide an inside of the cage into a plurality of regions and calculate errors between the plurality of divided regions to determine whether the cage has been tilted to a specific region among the plurality of regions.

The position adjusting device may include a plurality of position adjusting modules provided to respectively correspond to the plurality of regions and drive the plurality of position adjusting modules based on a measured value measured from the tilt measuring device.

The position adjusting device may be configured to generate integrated control information for integrally controlling the plurality of position adjusting modules based on the landing error measured through the sensor device when the tilt measuring device identifies that the cage has not been tilted to one region, and generate individual control information for individually controlling the plurality of position adjusting modules when the tilt measuring device identifies that the cage has been tilted to the one region.

Each of the plurality of position adjusting modules may include a connecting rope connecting the upper frame and the cage, a rotating gear provided in contact with the connecting rope, and a driver configured to apply a rotational force to the rotating gear, and perform positional compensation corresponding to each region of the cage based on a rotation direction and the number of rotations of the rotating gear.

The connecting rope may be provided to form two columns between the upper frame and the cage, and the rotating gear may include a plurality of gap holes into which the connecting rope forming the two columns is inserted and may be rotated through the driver in a state in which each connecting rope corresponding to each column is inserted into a corresponding one of two gap holes among the plurality of gap holes.

In another embodiment of the present disclosure, a position adjusting module included in an elevator is disclosed. The position adjusting module includes a connecting rope connecting an upper frame to which a main rope is connected and a cage, a rotating gear provided in contact with the connecting rope, and a driver configured to apply a rotational force to the rotating gear, wherein the connecting rope is provided to form two columns between the upper frame and the cage, and when the rotating gear is rotated, positional compensation of the cage is performed through crossing between the two columns of the connecting rope.

In still another embodiment of the present disclosure, a method of controlling landing of an elevator is disclosed. The method of controlling landing of an elevator includes acquiring a landing error related to a step difference between a cage and a floor through a sensor device, acquiring tilt detection information related to whether the cage has been tilted to a specific region through a tilt measuring device, and controlling a position adjusting device based on the landing error and the tilt detection information, wherein the position adjusting device includes a plurality of position adjusting modules provided between the cage and an upper frame provided with a main rope connected thereto, and each of the plurality of position adjusting modules includes a connecting rope connecting the upper frame and the cage, a rotating gear provided in contact with the connecting rope, and a driver configured to apply a rotational force to the rotating gear.

Other specific matters of the present disclosure are included in a detailed description and the accompanying drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 shows an exemplary view showing a structure of the conventional elevator related to one embodiment of the present disclosure;

FIGS. 2A and 2B are exemplary views showing a step difference formed between an elevator floor and a platform floor according to one embodiment of the present disclosure;

FIG. 3 is an exemplary view exemplarily showing an elevator landing control system according to one embodiment of the present disclosure;

FIG. 4 shows an exemplary block diagram of the elevator landing control system according to one embodiment of the present disclosure;

FIGS. 5A and 5B are exemplary views showing a situation in which a step difference is formed according to one embodiment of the present disclosure;

FIGS. 6A and 6B are exemplary views showing a situation in which a cage tilts according to one embodiment of the present disclosure;

FIGS. 7A and 7B are exemplary views showing a positional compensation operation performed through a position adjusting module according to one embodiment of the present disclosure;

FIG. 8 is an exemplary view exemplarily showing a connecting line and a rotating gear according to one embodiment of the present disclosure;

FIGS. 9A and 9B are exemplary views showing an inside of the cage divided into a plurality of regions according to one embodiment of the present disclosure; and

FIG. 10 is an exemplary view showing a position adjusting device implemented through a plurality of position adjusting modules according to one embodiment of the present disclosure.

### DETAILED DESCRIPTION OF EXEMPLARY EMBODIMENTS

Various embodiments and/or aspects are disclosed with reference to the accompanying drawings. In the following description, for purposes of description, numerous specific details are described to facilitate the general understanding of one or more aspects. However, it will also be understood by those skilled in the art that these aspect(s) may be carried out even without these specific details. The following description and the accompanying drawings describe certain exemplary aspects of one or more aspects in detail. However, these aspects are illustrative and some of the various methods in the principles of the various aspects may be used, and the described explanations are intended to include all of these aspects and equivalents thereto. Specifically, terms “embodiment,” “example,” “aspect,” “exemplary,” etc., when used herein, may not be construed as indicating that any aspect or design described is superior to or advantageous over other aspects or designs.

Hereinafter, the same reference numerals are given to the same or similar components regardless of reference numerals, and overlapping descriptions thereof will be omitted. In addition, in describing the embodiments disclosed in the specification, when it is determined that a detailed description of a related known technology may obscure the gist of the embodiments disclosed in the specification, the detailed description will be omitted. In addition, the accompanying drawings are only for better understanding of the embodiments disclosed in the specification, and the technical spirit disclosed in the specification is not limited by the accompanying drawings.

Although terms “first,” “second,” etc. are used to describe various devices or elements, it goes without saying that these devices or elements are not limited by these terms. These terms are only used to distinguish one device or element from another. Therefore, it goes without saying that a first device or element to be described below may also be a second device or element within the technical spirit of the present disclosure.

Unless otherwise defined, all terms (including technical and scientific terms) used in the specification may be used as the meaning commonly understood by those skilled in the art to which the present disclosure pertains. In addition, terms defined in commonly used dictionaries are not construed ideally or excessively unless explicitly specifically defined.

In addition, the term “or” is intended to mean an inclusive “or” rather than an exclusive “or.” In other words, unless otherwise specified or clear from the context, “X uses A or B” is intended to mean one of the natural inclusive substitutions. In other words, when X uses A, X uses B, or X uses both A and B, “X uses A or B” may also be applied to any one of these cases. In addition, the term “and/or” as used in the specification should be understood to indicate and include all possible combinations of one or more of the listed related items.

In addition, it should be understood that the terms “comprises” and/or “comprising” mean that the corresponding feature and/or component are present, but do preclude the presence or addition of one or more other features, components, and/or groups thereof. In addition, unless otherwise specified or the context clearly indicates that a singular form is indicated, the singular in the specification and claims should generally be construed to mean “one or more.”

It should be understood that when a certain element is described as being “connected” or “coupled” to another, the certain element may be directly connected or coupled to another, but other elements may be present therebetween. On the other hand, it should be understood that when a certain element is described as “directly connected” or “directly coupled” to another, no other elements are present therebetween.

The suffixes “module” and “unit” for the elements used in the following description are given or used interchangeably in consideration of ease of preparing the specification and do not have meanings or roles that are distinct from each other by themselves.

When an element or a layer is described as being “above” or “on” another element or layer, it includes both of not only a case of being directly on another element or layer but also a case of being on another element with other layers or elements interposed therebetween. On the other hand, when an element is described as being “directly on” or “directly above,” another, it indicates that no other element or layer is interposed therebetween.

Spatially relative terms “below,” “beneath,” “lower,” “above,” “upper,” etc. may be used to easily describe one element or a correlation between other elements as shown in the drawings. It should be understood that the spatially relative terms include different directions of the device in use or at operation in addition to the directions shown in the drawings.

For example, when an element shown in the drawings is flipped, the element described as being “below” or “beneath” another element may be positioned “above” another element. Therefore, the exemplary term “below” may correspond to both of a downward direction and an upward direction. The element may also be directed in other directions, and thus the spatially relative terms may be construed according to the directions.

Objects and effects of the present disclosure, and technical configurations for achieving them will become clear with reference to the embodiments described below in detail in conjunction with the accompanying drawings. In describing the present disclosure, when it is determined that a detailed description of a known function or configuration may unnecessarily obscure the gist of the present disclosure, the detailed description will be omitted. In addition, terms to be described below are terms defined in consideration of functions in the present disclosure, which may vary depending on the intention, custom, or the like of a user or an operator.

However, the present disclosure is not limited to embodiments disclosed below and may be implemented in various different forms. These embodiments are provided only to make the present disclosure complete and completely inform those skilled in the art of the scope of the disclosure to which the present disclosure pertains, and the present disclosure is only defined by the scope of the claims. Therefore, the definition should be made based on the contents throughout the specification.

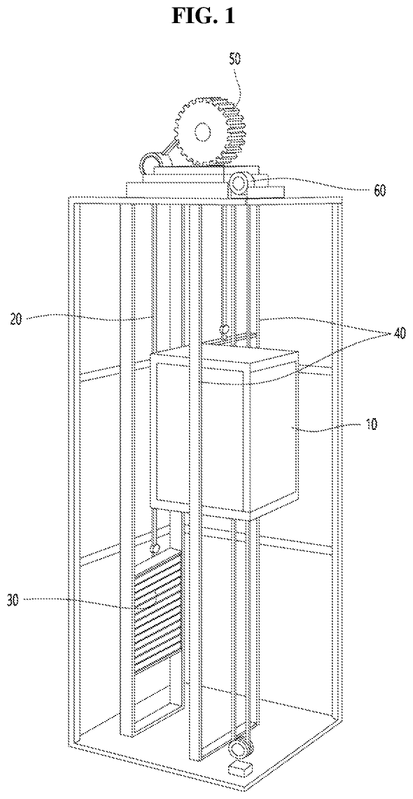

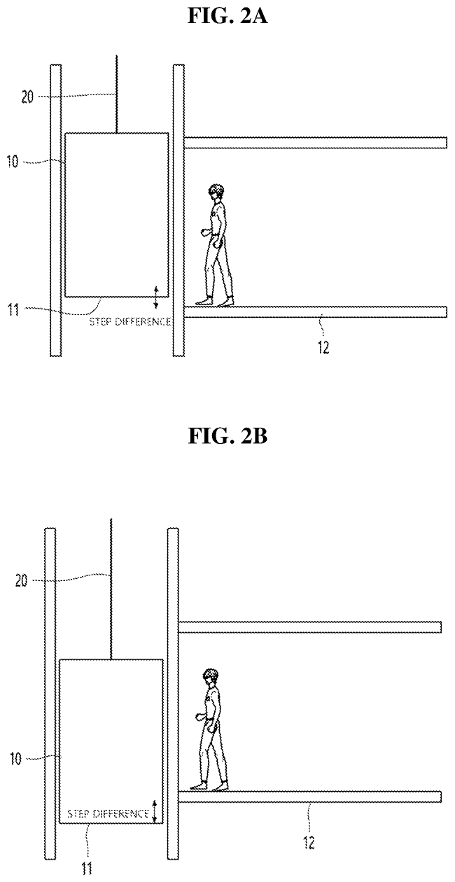

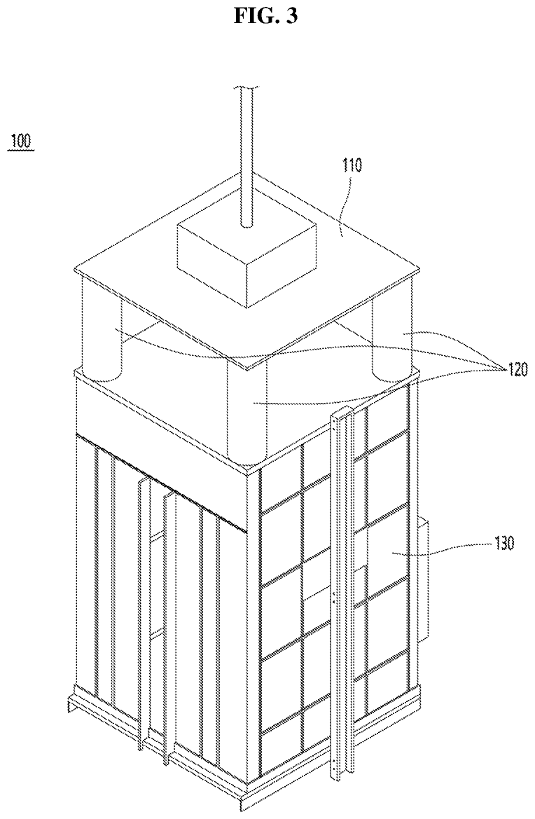

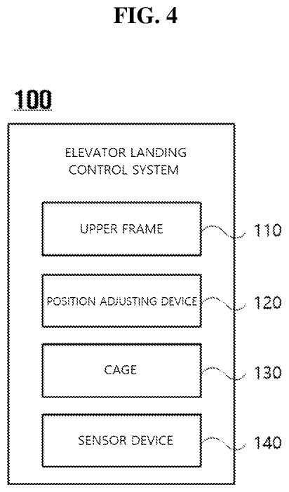

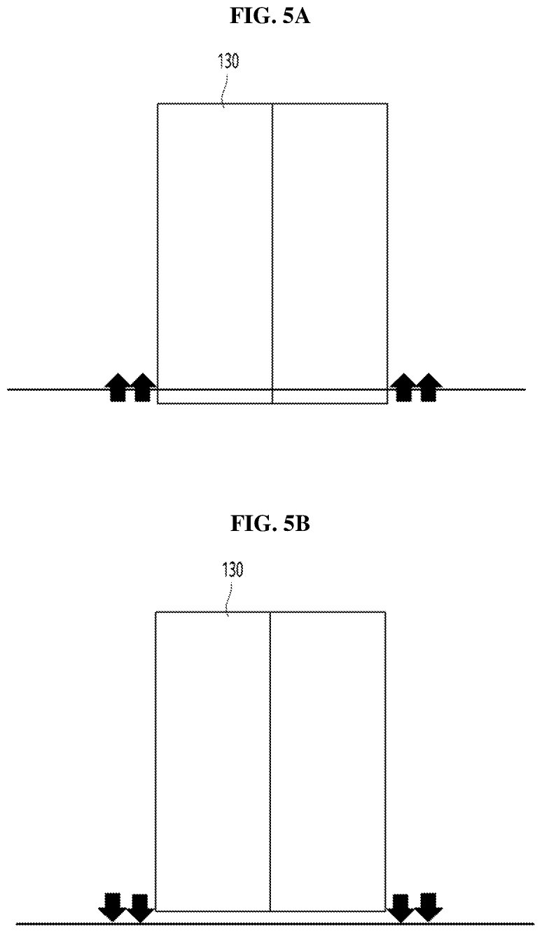

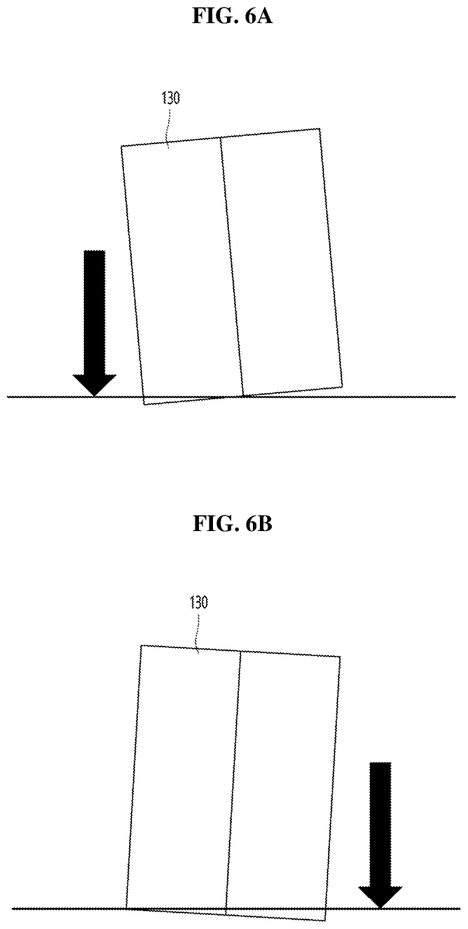

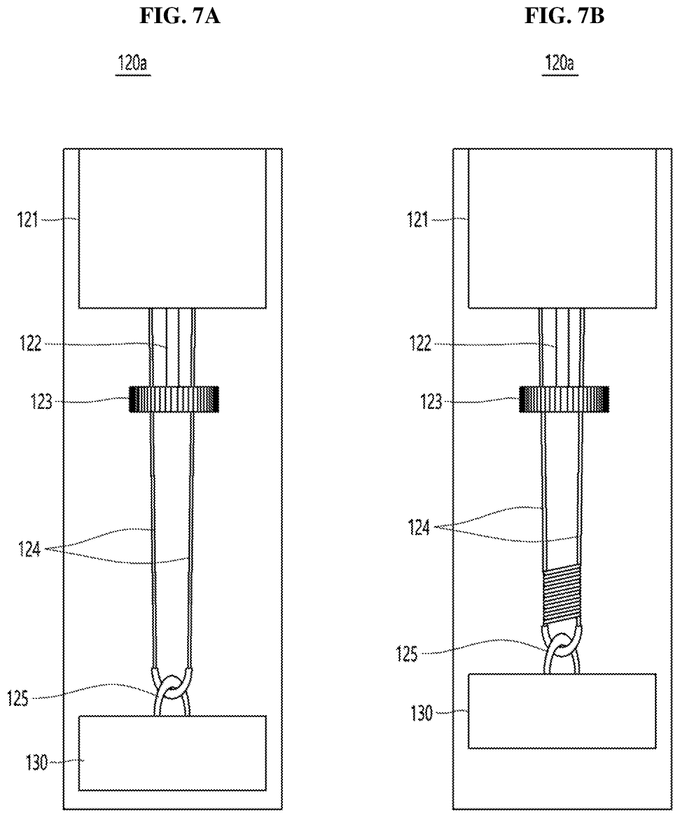

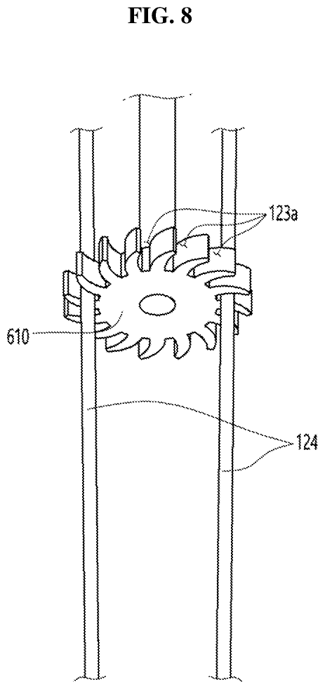

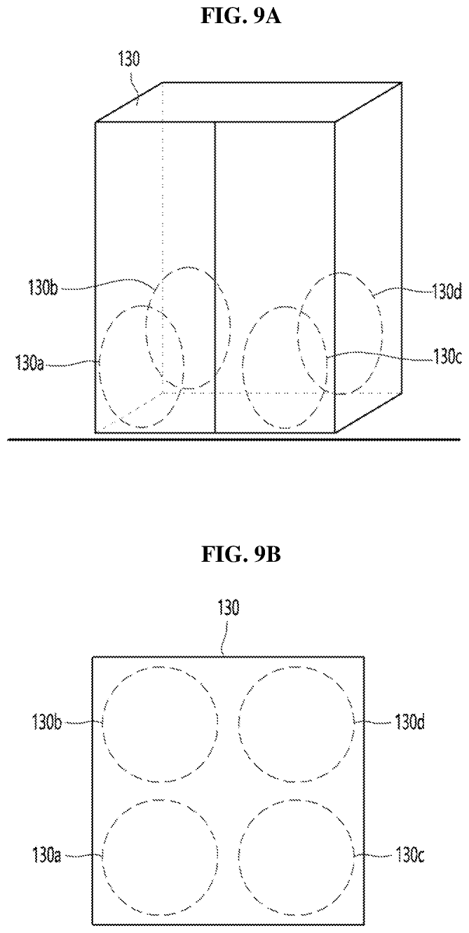

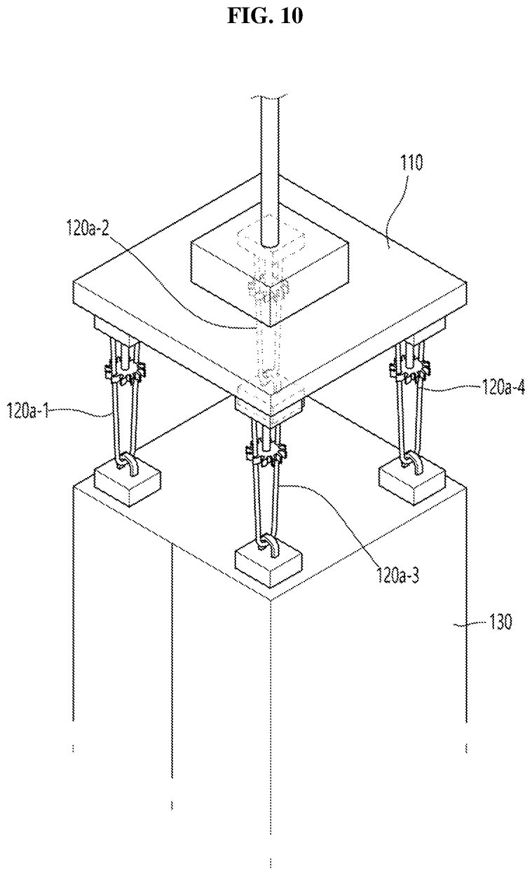

FIG. 1 shows an exemplary view showing a structure of the conventional elevator related to one embodiment of the present disclosure. FIGS. 2A and 2B are exemplary views showing a step difference formed between an elevator floor and a platform floor according to one embodiment of the present disclosure. FIG. 3 is an exemplary view exemplarily showing an elevator landing control system according to one embodiment of the present disclosure. FIG. 4 shows an exemplary block diagram of the elevator landing control system according to one embodiment of the present disclosure. FIGS. 5A and 5B are exemplary views showing a situation in which a step difference is formed according to one embodiment of the present disclosure. FIGS. 6A and 6B are exemplary views showing a situation in which a cage tilts according to one embodiment of the present disclosure. FIGS. 7A and 7B are exemplary views showing a positional compensation operation performed through a position adjusting module according to one embodiment of the present disclosure. FIG. 8 is an exemplary view exemplarily showing a connecting line and a rotating gear according to one embodiment of the present disclosure. FIGS. 9A and 9B are exemplary views showing an inside of the cage divided into a plurality of regions according to one embodiment of the present disclosure. FIG. 10 is an exemplary view showing a position adjusting device implemented through a plurality of position adjusting modules according to one embodiment of the present disclosure.

An elevator refers to a device for transporting passengers or cargo to each floor of a building while a car (e.g., a cage) on which the passengers get or the cargo is loaded moves up and down. As shown in FIG. 1, a typical elevator may include a fixed pulley (or a winch) 50 installed at an uppermost position of an operating passage of the elevator. The fixed pulley 50 may be connected to a main rope 20. The main rope 20 may be connected over the fixed pulley 50 and has one end connected to a cage 10 and the other end connected to a counterweight 30. The counterweight 30 is provided to have a weight similar to the cage 10 or a weight corresponding to 1.5 times the weight of the cage 10 and serves to reduce a load of a motor. In an embodiment, when the motor winds the main rope 20 in a forward direction, the cage 10 may move up, and when the motor winds the main rope 20 in a reverse direction, the cage 10 may move down. Guide rails 40 are provided at both surfaces of the cage 10 to serve to guide the cage 10 to move up and down. In other words, the cage 10 may move up and down along the guide rails 40. A speed governor 60 may be a device for safely stopping the cage 10 by operating at a preset speed when the cage 10 of the elevator is moving fast at a rated speed or higher. For example, in the speed governor 60, when the cage 10 is moving fast, an over speed switch may detect the over speed of the cage 10, cut off a power supply circuit, and activate an electromagnetic brake to stop the rotation of a speed governor pulley, thereby urgently stopping the cage 10 through a frictional force between a speed governor pulley groove and the rope. In other words, the speed governor 60 serves to safely stop the cage in an emergency situation.

Meanwhile, the elevator may cause a change in elasticity of the main rope 20 due to a change in amount of the load according to passengers getting on or off the cage 10, and a landing error may occur between a platform floor 12 and a cage floor 11. Therefore, as the cage 10 moves up and down, when the passenger gets off on a platform provided for each floor of the building or stops to get on the cage 10 from the platform, a stopped height of the cage, that is, a landing level of the cage needs to be adjusted for leveling of the cage 10 and the platform floors.

When the levels of the cage floor 11 and the platform floor 12 are not adjusted, a step difference may be formed because the leveling of the cage floor 11 and the platform floor 12 is not performed. For example, as shown in FIG. 2A, as the cage floor 11 is higher than the platform floor 12, the step difference is formed or as shown in FIG. 2B, as the platform floor 12 is higher than the cage floor 11, the step difference may be formed. There is a concern that such a step difference causes an accident, such as tripping and falling, when the passenger gets off on the platform from the cage or when the passenger gets on the cage from the platform.

Therefore, in order to stably operate the elevator, a landing level adjusting device needs to be installed to adjust a landing level of the cage so that the cage floor 11, which stops on a hall room provided on each floor of the building as the elevator moves up or down along a hoistway, and the platform floor 12 are leveled.

In general, in the landing level adjusting device, typically, by installing a level adjusting switch on an outer upper end of the cage and installing a switch operating unit at a position corresponding to each floor of the building of the guide rails 40 installed in the vertical and longitudinal direction along the hoistway, when the cage 10 stops at the platform of a desired floor while moving up or down along the hoistway, a level adjustment completion signal of the cage 10 is transmitted when the level adjusting switch installed on the outer upper end of the cage 10 is operated by the operating unit, and thus the landing level of the cage 10 is adjusted and the cage 10 is stopped.

In such a conventional general landing level adjusting device for an elevator, the landing level of the cage 10 is adjusted according to an installation position of the switch operating unit installed on the guide rail 40 for each floor of the building, and to this end, one worker positioned above the cage operates an elevating switch for low-speed operation installed on an upper portion of the cage 10 to move the cage up or down at low speed, and the other worker observes whether the cage floor and the platform floor are leveled or not inside the cage. When the other worker informs the one worker above the cage 10 of the fact that the landing level of the cage has been adjusted, the one worker turns off the operated elevating switch for low-speed operation, and the one worker above the cage 10 adjusts the installation position of the switch operating unit so that the level adjusting switch is operated at the level-adjusted position and the switch operating unit is installed on the guide rail 40 for each floor.

In the above-described conventional general elevator landing level adjusting device, two workers needs to install the switch operating unit on the guide rail while moving to each floor and checking the position at which the cage floor 11 and the platform floor 12 are leveled one by one, and thus many workers and man-hours of work need to be put into adjusting the landing level of the cage 10.

In addition, even when the switch operating unit is installed to correspond to each floor, the elasticity of the rope may be changed by the change in amount of load caused by the passengers getting on or off the cage, and thus the landing error may occur between the platform floor and the cage floor. In other words, the landing error may continuously occur while the elevator is continuously used.

The present disclosure may provide the elevator landing control system capable of measuring the landing error between the cage floor 11 and the platform floor 12 through various sensors when the elevator operates and performing positional compensation on the cage 10 based on the measured landing error. In other words, according to the present disclosure, it is possible to automatically detect and correct the position of the cage 10, thereby conveniently and continuously preventing the step difference that may be formed between the cage floor 11 and the platform floor 12. In addition, when the cage 10 is tilted or eccentric by the passengers' getting on or off the cage 10, the elevator landing control system according to the present disclosure may detect the tilt or eccentricity and perform positional compensation on the cage. Hereinafter, a detailed method of performing landing control through the elevator landing control system will be described with reference to FIGS. 3 to 10.

Referring to FIGS. 3 and 4, the elevator landing control system 100 according to the present disclosure may include an upper frame 110, a position adjusting device 120, a cage 130, and a sensor device 140. The above-described components are illustrative, and the elevator landing control system according to the present disclosure is not limited to the above-described components. In other words, additional components may be included or some of the above-described components may be omitted according to the implemented aspects of the embodiments of the present disclosure.

According to one embodiment of the present disclosure, the elevator landing control system 100 may include the cage 130 for transporting cargo and passengers. The cage 130 may include an entrance door and allow the cargo or the passengers to enter and exit the cage 130 through the entrance door. The cage 130 may provide a space in which the cargo or the passengers actually get on in order to move to other floors. A main rope may be provided in an upward direction of the cage 130, and the motor may wind the main rope in a forward direction or a reverse direction to move the cage 130 up and down. According to the embodiment, the elevator landing control system 100 may include the upper frame 110 provided in an upward of the cage 130 and provided with the main rope connected thereto. The upper frame 110 serves to connect the main rope and the cage 130. In other words, the cage 130 and the main rope may be connected through the upper frame 110. For example, as shown in FIG. 3, the cage 130 may be connected to one surface of the upper frame 110, and the main rope may be connected to the other surface thereof.

According to one embodiment of the present disclosure, the elevator landing control system 100 may include the position adjusting device 120 connecting the cage 130 and the upper frame 110. As shown in FIG. 3, the position adjusting device 120 may be provided between the cage 130 and the upper frame 110.

According to one embodiment, the position adjusting device 120 may include a plurality of position adjusting modules provided to respectively correspond to a plurality of regions. In a specific embodiment, the upper frame 110 may be provided in a quadrangular shape. In addition, the position adjusting device may include the plurality of position adjusting modules provided to respectively correspond to four corners included in the quadrangular upper frame 110. As shown in FIG. 3, four position adjusting modules may be provided to correspond to the four angles formed by the upper frame 110. In other words, the position adjusting device 120 may include the plurality of position adjusting modules corresponding to the plurality of regions. In the embodiment, each of the plurality of position adjusting modules may adjust a distance between the upper frame 110 and the cage 130 and compensate the overall position of the cage 130. According to the embodiment, each position adjusting module may individually adjust the distance between the upper frame 110 and the cage 130 corresponding to each region. For example, the position adjusting module positioned in a first region may perform an adjusting operation for reducing the distance between the upper frame 110 and the cage 130 compared to the position adjusting module positioned in a second region, which is another region. As another example, the position adjusting module positioned in a third region may not perform a separate operation for adjusting the distance between the upper frame 110 and the cage 130, and the position adjusting module positioned in a fourth region different from the third region may perform the adjusting operation for reducing the distance between the upper frame 110 and the cage 130. In other words, the position adjusting device may perform overall positional compensation on the cage 130 through each positing module provided in each individual region.

According to one embodiment of the present disclosure, the elevator landing control system 100 may include the sensor device 140 for detecting a landing error between the cage floor and the platform floor. For example, the sensor device 140 may be provided in a downward direction of the entrance door of the cage 130, and may detect the landing error between the cage floor and the platform floor. The sensor device 140 may include an infrared proximity sensor, an image sensor, a light detection and ranging (LiDAR) sensor, an ultrasonic sensor, etc. The proximity sensor may detect that the cage floor is lower than the platform floor, for example, as shown in FIG. 5A and detect that the platform floor is lower than the cage floor as shown in FIG. 5B. Such a proximity sensor may precisely measure a difference in height between the cage floor and the platform floor and detect the landing error.

In one embodiment, the position adjusting device 120 may adjust the distance between the upper frame 110 and the cage 130 on the basis of the landing error detected by the sensor device 140 and correct the height of the cage 130.

In a specific embodiment, when the sensor device 140 detects that the cage floor is lower than the platform floor as shown in FIG. 5A, the position adjusting device 120 may perform the adjusting operation of allowing the plurality of position adjusting modules to reduce the distance between the upper frame 110 and the cage 130. On the contrary, when the sensor device 140 detects that the platform floor is lower than the cage floor as shown in FIG. 5B, the position adjusting device 120 may perform the adjusting operation of allowing the plurality of position adjusting modules to increase the distance between the upper frame 110 and the cage 130.

According to the position adjusting operation of the position adjusting device 120, it is possible to adjust a height of the cage 130 from the platform floor, thereby eliminating a step difference formed by a difference in each floor. This has an advantage in that when the landing error occurring according to the weights of the passengers and the cargo or the landing error caused by the change in elasticity of the main rope while the elevator is continuously used, it is possible to automatically detect the landing error and compensate the position of the cage 130, thereby compensating the landing position and securing increased landing precision. In other words, it is possible to minimize an error range while the elevator is used, thereby increasing stability.

According to one embodiment, the above-described landing error does not occur only when the floor of the cage 130 is in a flat state as shown in FIGS. 5A and 5B and may also occur when the floor of the cage 130 tilts to one region as shown in FIGS. 6A and 6B. In the embodiment, whether the cage 130 has been tilted (or whether eccentricity has occurred) may be measured (or determined) through a tilt measuring device. The tilt measuring device may divide an inside of the cage 130 into a plurality of regions and calculate errors between the plurality of divided regions to determine whether the cage has been tilted into a specific region among the plurality of regions. In other words, the tilt measuring device may measure whether the cage floor is in a flat state and how much the tilted degree (e.g., eccentricity acting degree) is.

In one embodiment, the position adjusting device 120 may drive the plurality of position adjusting modules based on the sensing value measured by the tilt measuring device.

For example, as many passengers or a large amount of cargo are positioned in a specific region in the cage 130, the cage 130 may tilt in one direction. For example, as shown in FIG. 6A, as the cage tilts to the left side, a left floor of the cage may be lower than a right floor of the cage. In addition, as shown in FIG. 6B, as the cage tilts to the right side, the right floor of the cage may be lower than the left floor of the cage.

In this case, the position adjusting device 120 may individually adjust the plurality of position adjusting modules and perform positional compensation on the cage 130. As a specific example, as shown in FIG. 6A, when the cage tilts to the left side, the position adjusting device 120 may perform adjustment that allows position adjusting modules, which are related to a left region, among the plurality of position adjusting modules to highly reduce the distance between the upper frame 110 and the cage 130 and perform adjustment that allows the position adjusting modules, which are related to a right region, among the plurality of position adjusting modules to relatively slightly reduce the distance between the upper frame 110 and the cage 130. In other words, the position adjusting device 120 may perform positional compensation that increases a degree in which the left portion of the cage moves up and reduces a degree in which the right portion of the cage moves up in a process of preventing the landing error through the height adjustment of the cage 130, thereby preventing the landing error and at the same time, leveling the floor of the cage 130. In other words, the position adjusting device 120 according to the present disclosure may not only adjust the landing error, but also adjust the eccentricity that may occur according to the weight deviation applied to the inside of the cage 130, thereby increasing the stability of the device.

According to the embodiment, the elevator landing control system 100 may include the tilt measuring device for dividing the inside of the cage into the plurality of regions and calculating the errors between the plurality of divided regions to determine whether the cage 130 has been tilted to a specific region among the plurality of regions. The tilt measuring device may be implemented through a gyro sensor, a global positioning system (GPS) sensor, a weight detection sensor, etc. and may detect eccentricity that occurs in the cage 130. The tilt measuring device may be one component of the sensor device.

Each of the plurality of position adjusting modules may include a connecting rope 124 connecting the upper frame 110 and the cage 130, a rotating gear 123 provided in contact with the connecting rope 124, and a driver 121 for applying a rotational force to the rotating gear 123. A detailed description of one position adjusting module 120a will be described below with reference to FIGS. 7A, 7B and 8.

In one embodiment, the connecting rope 124 may be provided to form two columns between the upper frame 110 and the cage 130. Specifically, as shown in FIGS. 7A and 7B, a connecting ring 125 may be provided on an upper surface of the cage 130, and as one end of the connecting rope 124 is provided to pass through the connecting ring 125 to correspond to the other end thereof, the two columns may be formed between the upper frame 110 and the cage 130. In this case, each of the two columns formed by the connecting rope 124 may be provided to be connected to the rotating gear 123.

In the embodiment, as shown in FIG. 8, the rotating gear 123 may include a plurality of gap holes 123a into which the connecting rope 124 forming the two columns may be inserted. In this case, the rotating gear 123 may be rotated through the driver 121 in a state in which each of the connecting ropes 124 corresponding to each column is inserted into a corresponding one of the two gap holes among the plurality of gap holes 123a. The rotating gear 123 may be connected to the driver 121 through a rotating shaft 122. The driver 121 may rotate the rotating shaft 122 to supply a rotational force to the rotating gear 123. The driver 121 means a device for converting electrical energy into mechanical energy using a force received by a conductor through which a current flows in a magnetic field and rotates the rotating shaft 122 through the generated mechanical energy.

In the embodiment, when the rotating gear 123 is rotated, positional compensation on the cage 130 may be performed through crossing between the two columns of the connecting rope. In other words, when the rotating gear 123 is rotated, the two columns of the connecting rope 124 inserted into the corresponding gap holes of the rotating gear 123 may be twisted with each other, and as the connecting rope 124 is twisted, the position of the cage 130 may be adjusted. As a specific example, as shown in FIG. 7B, the distance between the upper frame 110 and the cage 130 may decrease more in a case in which the connecting rope 124 is twisted according to the rotation of the rotating gear 123 than in a case in which the connecting rope 124 is not twisted (i.e., see FIG. 7A). In other words, as the degree of twist increases, the distance between the upper frame 110 and the cage 130 may decrease.

The number of rotations of the rotating gear 123 is determined according to the rotational force applied through the driver 121, and the distance between the upper frame 110 and the cage 130 may be adjusted in response to the number of rotations of the rotating gear 123. For example, when the connecting rope 124 is twisted according to the rotation of the rotating gear 123, the distance between the upper frame 110 and the cage 130 may decrease, and conversely, when the twisted connecting rope 124 is released according to the rotation of the rotating gear 123, the distance between the upper frame 110 and the cage 130 may increase.

In one embodiment, each position adjusting module may perform positional compensation corresponding to each region of the cage 130 based on a rotation direction and RPM of the rotating gear 123. In other words, the distance between the upper frame 110 and the cage 130 may increase or decrease depending on whether the connecting rope 124 is rotated in a twisting direction or in a released direction, and an adjusted degree of the distance may be determined according to how much the degree of the rotation is.

For example, when the tilt measuring device identifies that the cage 130 has not tilted to one region, the position adjusting device 120 may generate integrated control information for integrally controlling the plurality of position adjusting modules based on the landing error measured through the sensor device 140. In other words, when eccentricity does not occur, the position adjusting device 120 may equally control the plurality of position adjusting modules in consideration of only the measured value (i.e., the landing error) of the sensor device 140. For example, when the eccentricity does not occur, each position adjusting module may perform the position adjusting operation to the same degree based on the landing error measured from the sensor device 140.

In addition, when the tilt measuring device identifies that the cage 130 has been tilted to one region, the position adjusting device 120 may generate individual control information for individually controlling the plurality of position adjusting modules.

In a specific embodiment, referring to FIGS. 9A, 9B and 10, the inside of the cage 130 may be divided into the plurality of regions, and each position adjusting module may be provided to a one corresponding region. FIG. 9A is an exemplary perspective view of the cage 130, and FIG. 9B is an example view of the cage 130 from above.

Specifically, the inside of the cage 130 may be divided into a first region 130a, a second region 130b, a third region 130c, and a fourth region 130d. In this case, a first position adjusting module 120a-1 may be provided to correspond to the first region 130a, a second position adjusting module 120a-2 may be provided to correspond to the second region 130b, a third position adjusting module 120a-3 may be provided to correspond to the third region 130c, and a fourth position adjusting module 120a-4 may be provided to correspond to the fourth region 130d.

In an embodiment, the tilt measuring device may divide the inside of the cage 130 into the plurality of regions and calculate errors between the plurality of divided regions to determine whether the cage has been tilted to the specific region among the plurality of regions.

When the cage 130 tilts or is eccentric to the specific region due to passengers getting on and off the cage 130, the position adjusting device 120 may allow each position adjusting module to perform different adjusting operations.

As a specific example, as many passengers or a large amount of cargo is positioned in the left region of the cage 130, the cage 130 may tilt in the left direction. In other words, eccentricity may occur in the left region of the cage 130. In this case, by allowing the drivers (i.e., a first driver and a second driver) corresponding to the first position adjusting module 120a-1 and the second position adjusting module 120a-2 related to the left region to apply a large rotational force to each rotating unit, and allowing the drivers (i.e., a third driver and a fourth driver) corresponding to the first position adjusting module 120a-1 and the second position adjusting module 120a-2 related to the right region to apply a relatively small rotational force to each rotating unit, positional compensation may be performed so that the floor of the cage 130 is leveled by increasing the degree of the left region moving up compared to the right region.

In addition, for example, as many passengers get on the first region of the cage 130, the cage 130 may tilt in a direction toward the first region. In this case, the first driver corresponding to the first position adjusting module 120a-1 supplies a larger rotational force to the corresponding rotating unit than the drivers corresponding to other position adjusting modules (e.g., the second position adjusting module to the fourth position adjusting module), and thus the positional compensation may be performed so that the floor of the cage 130 is leveled by increasing the degree of the first region moving up relatively compared to other regions. In other words, the position adjusting device 120 according to the present disclosure may not only adjust the landing error detected through the sensor device 140, but also detect the eccentricity that may occur according to the weight deviation applied to the cage 130 through the tilt measuring device and perform the individual adjustment for each region for suppressing the occurrence of eccentricity, thereby further increasing the stability of the device.

In a further embodiment, the position adjusting device 120 (or each position adjusting module) may acquire and store information on the landing error corresponding to each of the plurality of floors positioned in the building and may perform positional compensation on the cage 130 according to the stored landing error for each floor. The landing error for each floor may be re-detected and updated through a specific time period (e.g., 24 hours). For example, the landing error may appear differently for each layer. For example, a relatively larger landing error may occur on a fifth floor than on an eighth floor. In addition, for example, on a third floor, a landing error in which the cage floor is higher than the platform floor may occur, and on a ninth floor, a landing error in which the cage floor is lower than the platform floor may also occur. The position adjusting device 120 may perform a cage positional compensation operation for recording the information on the landing error for each layer and then correcting the landing error of the corresponding layer based on a landing error corresponding to a floor to which the passenger intends to move.

In addition, in the embodiment, the position adjusting device 120 (or each position adjusting module) may acquire change information of the landing error recorded for each floor and generate checking information based on the corresponding information. Specifically, the position adjusting device 120 may record the degree of change in the landing error for each floor every specific time period. For example, a landing error detected on the third floor at a first time point may be 1 cm, and a landing error detected on the third floor at a second time point (e.g., a time point 24 hours after the first time point) after the first time point may be 3 cm. In the embodiment, such a rapid change in the landing error may be related to a malfunction of a brake. In this case, the position adjusting device 120 may identify that the landing error has rapidly changed at a relatively short time interval to generate checking information for checking the elevator and transmit the generated checking information to a manager terminal and a manager server. In other words, the position adjusting device 120 may record the landing error change information for each floor at a predetermined time period, identify a singularity related to the checking through the aspect of the change in the landing error, and transmit the singularity to the manager so that the elevator is continuously managed, thereby further increasing the stability of the elevator.

According to various embodiments of the present disclosure, a landing control system capable of correcting a step difference between a platform floor and an elevator floor through positional compensation of the elevator can be provided.

In addition, when a specific region of a cage tilts (or is eccentric), it is possible to detect the tilt (or the eccentricity) and perform individual positional compensation on each of a plurality of regions, thereby suppressing the tilting phenomenon.

The effects of the present disclosure are not limited to the above-described effects, and other effects that are not mentioned will be able to be clearly understood by those skilled in the art from the above detailed description.

Although embodiments of the present disclosure have been described above with reference to the accompanying drawings, those skilled in the art to which the present disclosure pertains will be able to understand that the present disclosure may be carried out in other specific forms even without changing the technical spirit or essential features of the present disclosure. Therefore, it should be understood that the above-described embodiments are illustrative and not restrictive in all respects.

It should be understood that the specific order or hierarchy of operations in the suggested processes is an example of exemplary approaches. It should be understood that the specific order or hierarchy of operations in the processes may be re-arranged based upon design priorities within the scope of the present disclosure. The accompanying method claims provide elements of the various operations in a sample order, but are not intended to be limited to the suggested specific order or hierarchy.

What is claimed is:

1. An elevator landing control system comprising:
an upper frame provided in an upward direction of a cage and provided with a main rope connected thereto;
a position adjusting device configured to connect the cage and the upper frame; and
a sensor device configured to detect a landing error between a floor of the cage and a floor of a platform,
wherein the position adjusting device adjusts a distance between the upper frame and the cage based on the landing error detected from the sensor device to correct a height of the cage.

2. The elevator landing control system of claim 1, further comprising a tilt measuring device configured to divide an inside of the cage into a plurality of regions and calculate errors between the plurality of divided regions to determine whether the cage has been tilted to a specific region among the plurality of regions.

3. The elevator landing control system of claim 2, wherein the position adjusting device includes a plurality of position adjusting modules provided to respectively correspond to the plurality of regions and drives the plurality of position adjusting modules based on a measured value measured from the tilt measuring device.

4. The elevator landing control system of claim 3, wherein the position adjusting device is configured to:
generate integrated control information for integrally controlling the plurality of position adjusting modules based on the landing error measured through the sensor device when the tilt measuring device identifies that the cage has not been tilted to one region; and
generate individual control information for individually controlling the plurality of position adjusting modules when the tilt measuring device identifies that the cage has been tilted to the one region.

5. The elevator landing control system of claim 4, wherein each of the plurality of position adjusting modules includes a connecting rope connecting the upper frame and the cage, a rotating gear provided in contact with the connecting rope, and a driver configured to apply a rotational force to the rotating gear, and
performs positional compensation corresponding to each region of the cage based on a rotation direction and the number of rotations of the rotating gear.

6. The elevator landing control system of claim 5, wherein the connecting rope is provided to form two columns between the upper frame and the cage, and
the rotating gear includes a plurality of gap holes into which the connecting rope forming the two columns is inserted and is rotated through the driver in a state in which each connecting rope corresponding to each column is inserted into a corresponding one of two gap holes among the plurality of gap holes.

7. A position adjusting module included in an elevator, comprising:
a connecting rope connecting an upper frame to which a main rope is connected and a cage;
a rotating gear provided in contact with the connecting rope; and
a driver configured to apply a rotational force to the rotating gear,
wherein the connecting rope is provided to form two columns between the upper frame and the cage, and
when the rotating gear is rotated, positional compensation is performed on the cage through crossing between the two columns of the connecting rope.

8. A method of controlling landing of an elevator, comprising:
acquiring a landing error related to a step difference between a cage and a floor through a sensor device;
acquiring tilt detection information related to whether the cage has been tilted to a specific region through a tilt measuring device; and
controlling a position adjusting device based on the landing error and the tilt detection information,
wherein the position adjusting device includes a plurality of position adjusting modules provided between the cage and an upper frame provided with a main rope connected thereto, and
each of the plurality of position adjusting modules includes a connecting rope connecting the upper frame and the cage, a rotating gear provided in contact with the connecting rope, and a driver configured to apply a rotational force to the rotating gear.
